(19) United States
(12) Patent Application Publication
(10) Pub. No.: US 2026/0213461 A1
(43) Pub. Date: Jul. 23, 2026

(54) Electrical Connector

(71) Applicants: APTIV CONNECTION SYSTEMS (NANTONG) LTD., Jiangsu (CH); APTIV ELECTRICAL CENTERS (SHANGHAI) CO. LTD., Shanghai (CN)

(72) Inventor: Xiaoxian TIAN, Shanghai (CN)

(21) Appl. No.: 19/457,337

(22) Filed: Jan. 23, 2026

(30) Foreign Application Priority Data
Jan. 23, 2025 (CN) 202510116137.1

(51) Int. Cl. H01R 13/639; H01R 13/52; H01R 24/38

(52) U.S. Cl. CPC H01R 13/639; H01R 13/52; H01R 24/38

(57) ABSTRACT

According to this disclosure, an electrical connector is proposed. The electrical connector comprises: a main housing with a terminal channel formed therein, and a terminal clamping arm is formed in the terminal channel; and a terminal locking member to be mounted onto the main housing, thereby compressing the terminal clamping arm to deform and therefore apply enhanced locking to the terminal, wherein, the terminal locking member and the main housing have a pre-locking position and a final-locking position.

### CROSS-REFERENCE TO RELATED APPLICATION

This application claims the benefit of and priority to Chinese Patent Application 202510116137.1 on Jan. 23, 2025, the contents of which are incorporated by reference herein.

### TECHNICAL FIELD OF THE INVENTION

This disclosure relates to the technical field of connector technology, particularly, relates to electrical connectors used in automotive electrical and electronic architecture.

### BACKGROUND

Coaxial connectors are often used as signal connectors in automotive electrical and electronic architectures. A common coaxial connector includes an outer housing, terminal locking component, connector locking components (CPA device), etc. This type of terminal locking component is usually an independent device separate from the outer housing. In the delivery state, the terminal locking component is transported together with the outer housing but not assembled together. The terminal locking component is to be assembled with the outer housing by the end user.

If the terminal locking component mentioned above is not installed into the outer housing, or assembled at a wrong position, it will result in insufficient locking force of the connector, leading to connection failure. Therefore, there is still a need for further improvement in the locking performance and user experience of terminal locking components.

### SUMMARY

The present application aims to provide an electrical connector with terminal locking member which enhances locking performance and user experience.

According to one aspect of this application, an electrical connector is proposed. The electrical connect comprises: an electrical connector comprising: a main housing with a terminal channel formed therein, and a terminal clamping arm is formed in the terminal channel; and a terminal locking member to be mounted onto the main housing, thereby compressing the terminal clamping arm to deform and therefore apply enhanced locking to the terminal, wherein, the terminal locking member and the main housing have a pre-locking position and a final-locking position.

In the above solution of electrical connector, as an optional implementation, the terminal locking member is side-mounted type.

In the above solution of electrical connector, as an optional implementation, the main housing comprises a front cavity, a middle cavity, and a rear cavity that are connected to each other, and the terminal locking member comprises a terminal pressing plate for entering the middle cavity of the main housing, thereby compressing the terminal clamping arm and causing its deformation.

In the above solution of electrical connector, as an optional implementation, the terminal locking member comprises latching arms located on both sides, and the main housing comprises a pair of first clamping protrusions and a pair of second clamping protrusions located on both sides, when the latching arms are clamped to the first clamping protrusions, the terminal locking member is in the pre-locking position, and when the latching arms are clamped to the second clamping protrusions, the terminal locking member is in the final-locking position.

In the above solution of electrical connector, as an optional implementation, the first clamping protrusion and the second clamping protrusion are located at the rear portion of the main housing.

In the above solution of electrical connector, as an optional implementation, the terminal locking member comprises a first substrate and a second substrate connected to each other, wherein the first substrate is used to be attached to the rear portion of the main housing, and the latching arms are located on both sides of the first substrate.

In the above solution of electrical connector, as an optional implementation, a bottom opening is formed in the middle portion of the main housing, and the second substrate is to seal the bottom opening of the main housing.

In the above solution of electrical connector, as an optional implementation, a terminal pressing plate is formed on the second substrate, and the terminal pressing plate is to enter into the middle cavity through the bottom opening.

In the above solution of electrical connector, as an optional implementation, a boss is formed on the second substrate, and the terminal pressing plate is formed on the boss.

In the above solution of electrical connector, as an optional implementation, a side sealing structure is provided at the bottom opening of the main housing for providing sealing between the boss and the main housing.

In the above solution of electrical connector, as an optional implementation, when the terminal locking member and the main housing are in a pre-locking position, the side sealing structure provides sealing between the protrusion and the main housing.

In the above solution of electrical connector, as an optional implementation, the electrical connector comprises a one-piece integrated seal, the integrated seal comprising a front sealing ring, a rear sealing ring, and a side sealing plate, the side sealing plate serving as the side sealing structure.

### BRIEF DESCRIPTION OF THE DRAWINGS

In order to provide a clearer explanation of the technical solution in the embodiments of the present disclosure, a brief introduction will be given to the drawings required for the description of the embodiments. It is apparent that the drawings described below are only some embodiments of the present disclosure. For those skilled in the art, other drawings can be obtained based on these drawings without creative labor.

FIG. 1 is an exploded view of an electrical connector according to an embodiment of the present application.

FIG. 2 is a perspective view of the assembled state of the electrical connector shown in FIG. 1.

FIG. 3 is a perspective view of the main housing in the electrical connector.

FIG. 4 is a front view of the front end of the main housing in the electrical connector.

FIG. 5 is a longitudinal sectional view of the main housing in the electrical connector.

FIG. 6 is a perspective view of the seal in the electrical connector.

FIG. 7 is a perspective view of the side mounted terminal locking member in the electrical connector.

FIG. 8 is a schematic diagram of the spatial relationship between the side mounted terminal locking member and the seal.

FIG. 9 is a front elevation view of electrical connector.

FIG. 10 is a cross-sectional view taken along the A-A line in FIG. 9.

FIG. 11 is a side view of electrical connector.

FIG. 12 is a cross-sectional view taken along the line B-B in FIG. 11.

FIG. 13 is a cross-sectional view taken along the line C-C in FIG. 11.

### DETAILED DESCRIPTION

The following will provide a clear and complete description of the technical solution in the embodiments of the present application, in conjunction with the accompanying drawings. Obviously, the described embodiments are only a part of the embodiments of the present application, not all of them. Based on the embodiments in this application, all other embodiments obtained by those skilled in the art without creative labor are within the scope of protection of this application.

In the description of this application, it should be noted that unless otherwise specified and limited, the terms “connected” and “connected” should be broadly understood, for example, they can be fixed connections, detachable connections, or integrated connections; It can be a mechanical connection, an electrical connection, or communication with each other; It can be directly connected or indirectly connected through an intermediate medium, and it can be a connection within two components or an interaction relationship between two components. For ordinary technical personnel in this field, the specific meanings of the above terms in this application can be understood according to the specific situation. In the description of this application, the meaning of “multiple” refers to two or more, unless otherwise specifically limited. In addition, the terms “first” and “second” are only used for descriptive purposes and cannot be understood as indicating or implying relative importance or implying the number of technical features indicated. Thus, the features limited to “first” and “second” may explicitly or implicitly include one or more features.

The following disclosure provides many different implementation methods or examples to achieve different structures of the present application. In order to simplify the disclosure of this application, specific examples of components and settings are described below. Of course, they are only examples and are not intended to limit the scope of this application.

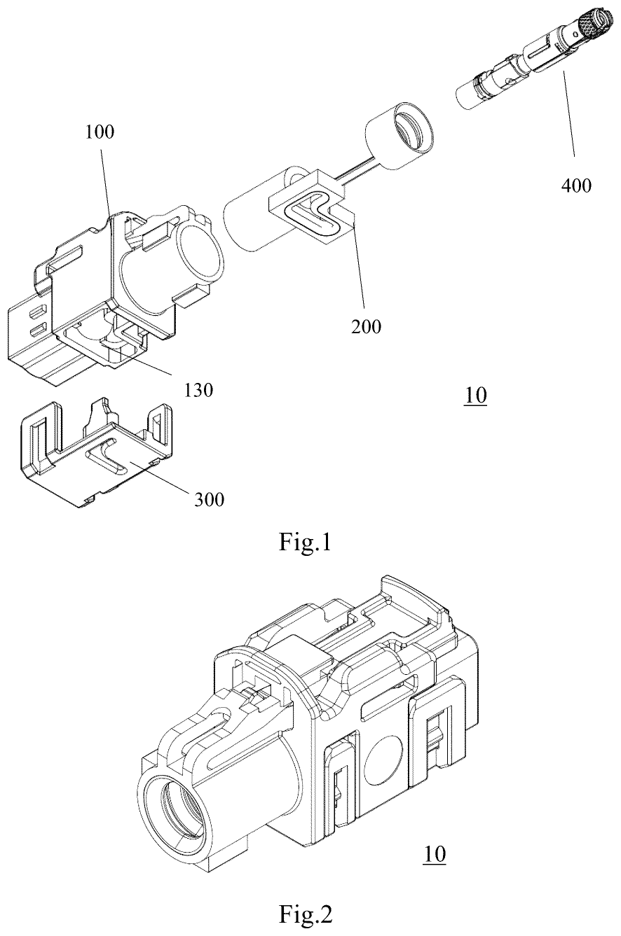

FIG. 1 shows an exploded view of an electrical connector 10 according to an embodiment of the present application. As shown in FIG. 1, the electrical connector 10 includes a main housing 100, a seal 200, a side-mounted type terminal locking member 300, and a terminal assembly 400 installed in the electrical connector 10. FIG. 2 is a perspective view of the assembled state of the electrical connector 10 shown in FIG. 1.

It can be understood that the terminal locking member is also referred to as the terminal primary lock reinforcement mechanism, or simply PLR.

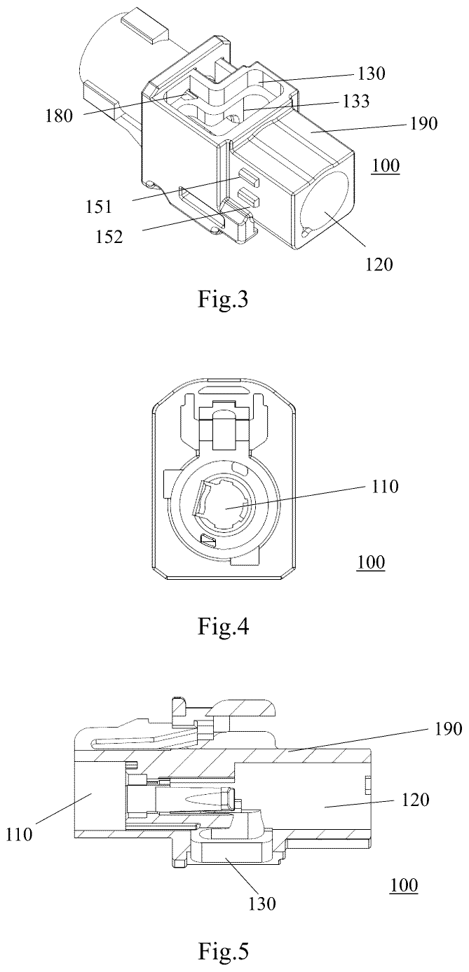

FIG. 3 is a perspective view of the main housing 100 in the electrical connector 10, in which the bottom opening 130 and the rear wire entrance inlet 120 of the main housing 100 can be observed.

FIG. 4 is a front view of the front end of the main housing 100 in the electrical connector 10. In FIG. 4, the front opening 110 of the main housing 100 can be observed.

FIG. 5 is a longitudinal sectional view of the main housing 100 in the electrical connector 10. It can be seen that the main housing 100 includes an integrated shell 190, a front opening 110, a bottom opening 130, and a rear wire entrance inlet 120 all formed on the shell 190 of the main housing 100, and these openings are connected to each other.

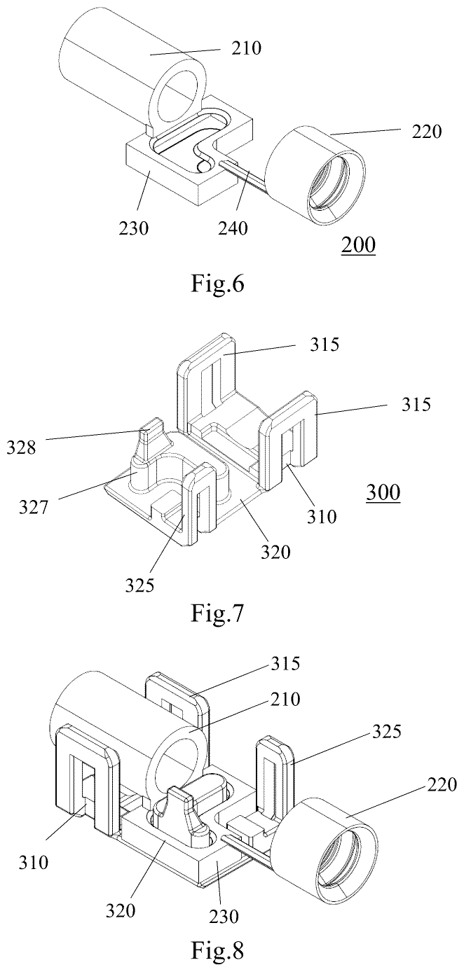

FIG. 6 is a perspective view of the seal 200 in the electrical connector 10. As shown in FIG. 6, the seal 200 comprises a rear sealing ring 210, a front sealing ring 220, and a side sealing plate 230 serving as the side sealing structure of the main housing 100. The rear sealing ring 210 is connected to the side sealing plate 230, and the side sealing plate 230 is connected to the front sealing ring 220 through a connecting rod 240. Therefore, seal 200 is a one-piece integral part.

FIG. 7 is a perspective view of the side mounted terminal locking member 300 in the electrical connector 10, and FIG. 8 is a schematic diagram of the spatial relationship between the side mounted terminal locking member 300 and the seal. As shown in FIG. 7, the side mounted terminal locking member 300 comprises a substrate structure, for example, the substrate structure may include a first substrate 310 and a second substrate 320 connected to each other.

Referring to FIG. 3, the first substrate 310 is to adhere to the rear bearing surface of the bottom of the main housing 100. On both sides of the first substrate 310, a pair of U-shaped latching arms 315 are provided, and the latching arms 315 can be clamped onto the clamping protrusions on the side of the main housing 100 shown in FIG. 3. Referring further to FIG. 3, latching protrusion at lateral sides of the main housing 100 comprises a first clamping protrusion 151 and a second clamping protrusion 152. The first clamping protrusion 151 is closer to the bottom of the main housing 100 than the second clamping protrusion 152. Therefore, the first clamping protrusion 151 is used for pre-locking, and the second clamping protrusion 152 is used for final-locking.

The second substrate 320 is to seal the bottom opening 130 of the main housing 100. On one side of the second substrate 320, a U-shaped latching arm 325 is formed. Referring to FIG. 2, on a single side of the main housing 100, a concave surface is formed, in which a clamping protrusion that cooperates with the U-shaped latching arm 325 is formed. By setting a concave surface formed on a single side, the user can be prompted with the unique and correct assembly position and direction of the side mounted terminal locking member 300.

A boss 327 is further provided on the second substrate 320, and a terminal pressing plate 328 is formed on the boss 327. The terminal pressing plate 328 is used to apply enhanced locking to the terminals of the main housing 100, details of which will be described in conjunction with other figures of this embodiment.

It can be understood that due to the need to avoid the single-sided U-shaped latching arm 325 formed on the second substrate 320, the boss 327 is an asymmetric irregular structure, for example, it is L-shaped as shown in FIG. 7. Correspondingly, an L-shaped entrance channel 133 corresponding to the shape of the boss 327 is formed at the bottom opening 130 of the main housing 100 (see FIG. 3).

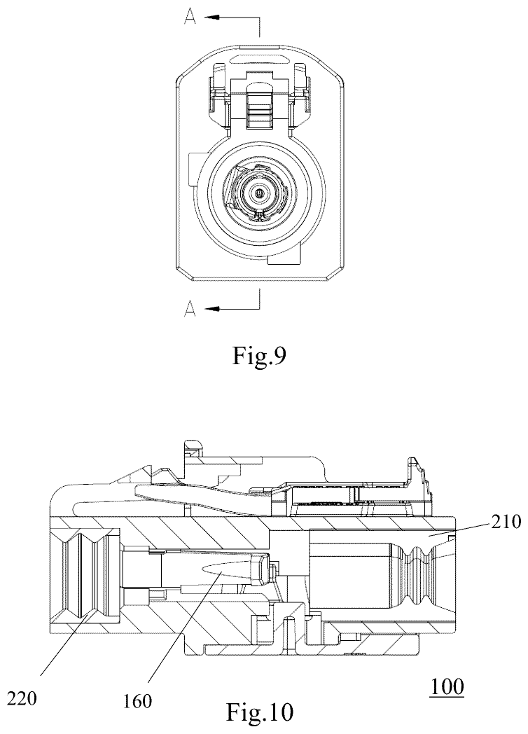

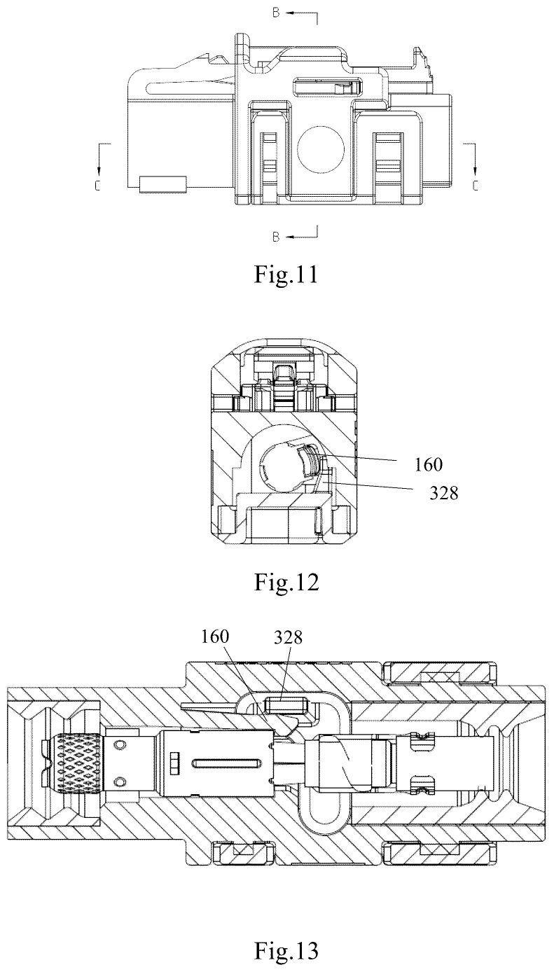

FIG. 9 is a front elevation view of electrical connector 10, and FIG. 10 is a cross-sectional view taken along the A-A line in FIG. 9. FIG. 11 is a side view of electrical connector 10, FIG. 12 is a cross-sectional view taken along the line B-B in FIG. 11, and FIG. 13 is a cross-sectional view taken along the line C-C in FIG. 11.

Based on FIG. 10 and FIGS. 12-13, it can be understood that a terminal clamping arm 160 is provided in the terminal channel structure of the main housing 100. External force can cause the free end of the terminal clamping arm 160 to make it move towards the terminal channel. When the side-mounted terminal locking member 300 is installed into the main housing 100 and is in the final-locking position provided by the second clamping protrusion 152, the terminal pressing plate 328 can press the terminal clamping arm 160 in the main housing 100 from a lateral side, causing its free end to move into the terminal channel, thereby applying enhanced locking to the terminal installed into the main housing 100.

It can be understood that when the side mounted terminal locking member 300 is installed into the main housing 100 and in the pre-locking position provided by the first clamping protrusion 151, the terminal clamping arm 160 has not yet been compressed by the terminal pressing plate 328, and therefore has not undergone deformation.

It can be understood that the opening shape on the side sealing plate 230 of the seal 200 matches with the boss 327. Therefore, when the side mounted terminal locking member 300 and the main housing 100 are in the pre-locked position, a waterproof sealing effect is provided.

As an optional implementation, the seal 200 and the main housing 100 can be made through co-molding process, thereby reducing production process steps and assembly operation steps. Correspondingly, as shown in FIG. 3, a connecting hole 180 can be formed on the main housing 100 to connect the front portion and middle portion of the housing, thereby facilitating the integrated molding of the front sealing ring 220, side sealing plate 230, and connecting rod 240 of the seal 200.

The above provides a detailed introduction to a connector provided in the embodiments of the present application. Specific examples are applied in the present application to explain the principles and implementation methods of the present application. The above embodiments are only used to help understand the technical solution and core idea of the present application; Ordinary technical personnel in this field should understand that they can still modify the technical solutions described in the aforementioned embodiments, or equivalently replace some of the technical features; And these modifications or substitutions do not deviate from the essence of the corresponding technical solutions from the scope of the technical solutions of the various embodiments of the present application.

1. An electrical connector comprising:
a main housing with a terminal channel formed therein, and a terminal clamping arm is formed in the terminal channel; and
a terminal locking member to be mounted onto the main housing, thereby compressing the terminal clamping arm to deform and therefore apply enhanced locking to the terminal,
wherein, the terminal locking member and the main housing have a pre-locking position and a final-locking position.

2. The electrical connector as claimed in claim 1, wherein the terminal locking member is side-mounted type.

3. The electrical connector as claimed in claim 1, wherein the main housing comprises a front cavity, a middle cavity, and a rear cavity that are connected to each other, and the terminal locking member comprises a terminal pressing plate for entering the middle cavity of the main housing, thereby compressing the terminal clamping arm and causing its deformation.

4. The electrical connector as claimed in claim 3, wherein the terminal locking member comprises latching arms located on both sides, and the main housing comprises a pair of first clamping protrusions and a pair of second clamping protrusions located on both sides, when the latching arms are clamped to the first clamping protrusions, the terminal locking member is in the pre-locking position, and when the latching arms are clamped to the second clamping protrusions, the terminal locking member is in the final-locking position.

5. The electrical connector according to claim 4, wherein the first clamping protrusion and the second clamping protrusion are located at a rear portion of the main housing.

6. The electrical connector according to claim 4, wherein the terminal locking member comprises a first substrate and a second substrate connected to each other, wherein the first substrate is used to be attached to a rear portion of the main housing, and the latching arms are located on both sides of the first substrate.

7. The electrical connector according to claim 6, wherein a bottom opening is formed in a middle portion of the main housing, and the second substrate is to seal the bottom opening of the main housing.

8. The electrical connector according to claim 6, wherein a terminal pressing plate is formed on the second substrate, and the terminal pressing plate is to enter into the middle cavity through a bottom opening.

9. The electrical connector according to claim 8, wherein a boss is formed on the second substrate, and the terminal pressing plate is formed on the boss.

10. The electrical connector according to claim 9, wherein a side sealing structure is provided at the bottom opening of the main housing for providing sealing between the boss and the main housing.

11. The electrical connector according to claim 10, wherein when the terminal locking member and the main housing are in a pre-locking position, the side sealing structure provides sealing between the protrusion and the main housing.

12. The electrical connector according to claim 11, wherein the electrical connector comprises a one-piece integrated seal, the integrated seal comprising a front sealing ring, a rear sealing ring, and a side sealing plate, the side sealing plate serving as the side sealing structure.
